(19) United States
(12) Patent Application Publication
(10) Pub. No.: US 2010/0002284 A1
(43) Pub. Date: Jan. 7, 2010

(54) METHOD OF MODULATING RESONANT FREQUENCY OF TORSIONAL MEMS DEVICE

(76) Inventors: Long-Sun Huang, Taipei City (TW); Hsien-Lung Ho, Taipei County (TW)

Correspondence Address: NORTH AMERICA INTELLECTUAL PROPERTY CORPORATION, P.O. BOX 506, MERRIFIELD, VA, 22116, US

(21) Appl. No.: 12/207,495

(22) Filed: Sep. 9, 2008

(30) Foreign Application Priority Data
Jul. 2, 2008 (TW) 097124875

(51) Int. Cl. G02B 26/00

(52) U.S. Cl. 359/290

(57) ABSTRACT

A method of modulating resonant frequency of a torsional MEMS device is provided. A torsional MEMS device is provided and a resonant frequency test is performed to measure a raw frequency of the torsional MEMS device. If the raw resonant frequency of the torsional MEMS device is greater than a standard resonant frequency, at least one mass increaser is bonded to the torsional MEMS device. Therefore, the raw resonant frequency is reduced as much as the standard resonant frequency.

### BACKGROUND OF THE INVENTION

1. Field of the Invention

The present invention is related to a method of modulating resonant frequency of a torsional MEMS device, and particularly, to a method of modulating resonant frequency of a torsional MEMS device by means of bonding at least a mass increaser to the torsional MEMS device.

2. Description of the Prior Art

In the past years, MEMS devices have been developed for miniaturization of mechanical devices. The MEMS devices are manufactured by processes used for forming integrated circuits. Typical MEMS devices, including micro-gears, micro-levers, and micro-valves, are operated in company with related electrical circuits to form several devices, such as accelerometers, pressure and chemical sensors, and actuators.

MEMS devices are formed using silicon as material. The silicon materials are processed by several semiconductor processes to form the structures of the MEMS devices. For example, torsional MEMS devices use hinge as the motive structure. The figure of the hinge is a major factor for determining the resonant frequency of the torsional MEMS devices. In addition, resonant frequency is also a major factor for determining the performance of the torsional MEMS device. Therefore, several processes are performed to manufacture the hinge and to modify the hinge having desirable resonant frequency. It is appreciated that demands of the resonant frequency of the torsional MEMS device is getting more accurate, and it is getting difficult to form the hinge of determined shape by a simple lithography process or an etch process at present. As a result, applicant provides a torsional MEMS device which the resonant frequency of the torsional MEMS device may be adjusted to overcome the limitation resulted from the present processes for forming the conventional torsional MEMS devices. Additionally, the resonant frequency of the torsional MEMS device of the present invention may be adjusted after the manufacturing processes thereof to match the resonant frequency standard of the product.

### SUMMARY OF THE INVENTION

It is therefore a primary objective of the present invention to provide a method of modulating the resonant frequency of a torsional MEMS device. After the main structure of the torsional MEMS device is formed, the resonant frequency of the torsional MEMS device is modulated by means of bonding the mass increaser to the torsional MEMS device for fulfilling the requirement of the product.

According to the present invention, a method of modulating resonant frequency of a torsional MEMS device is disclosed. Initially, a torsional MEMS device having a support structure, a platform, and at least connecting bars connected between the platform and the support structure is provided. A resonant frequency test is performed to measure a raw resonant frequency of the torsional MEMS device. If the raw resonant frequency of the torsional MEMS device is greater than a standard resonant, at least one mass increaser is bonded to the platform to increase the total mass of the torsional MEMS device for reducing the raw resonant frequency approaching to the standard resonant frequency.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 and FIG. 2 are schematic diagrams illustrating a method of modulating resonant frequency of a torsional MEMS device according to a preferred embodiment of the present invention.

FIG. 3 is a flow diagram of a method for modulating the resonant frequency of the torsional MEMS device according to a preferred embodiment of the present invention.

FIG. 4 is a schematic diagram illustrating a structure of a torsional MEMS device.

FIG. 5a is a cross-sectional view diagram of the torsional MEMS device 31.

FIG. 5b is a bottom view diagram of the torsional MEMS device.

### DETAILED DESCRIPTION

In the following detailed description, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

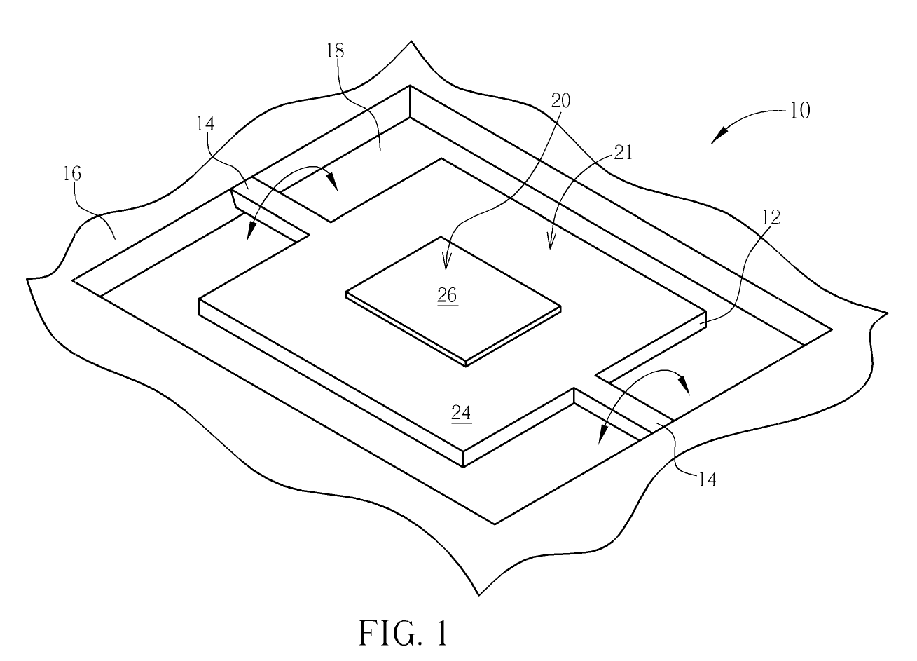

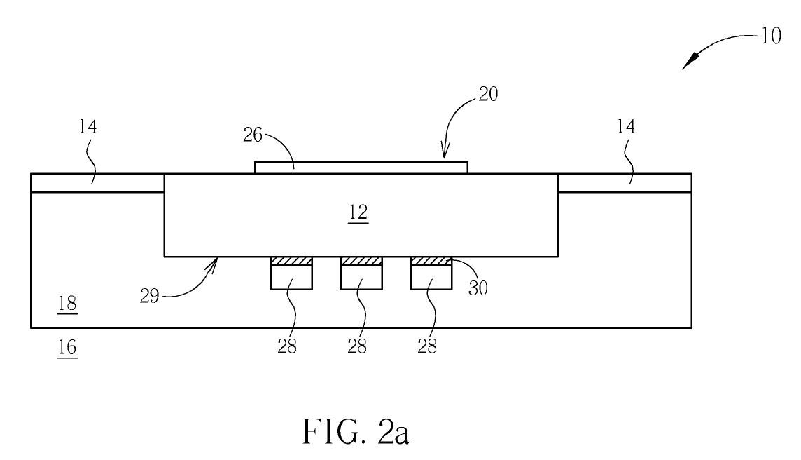

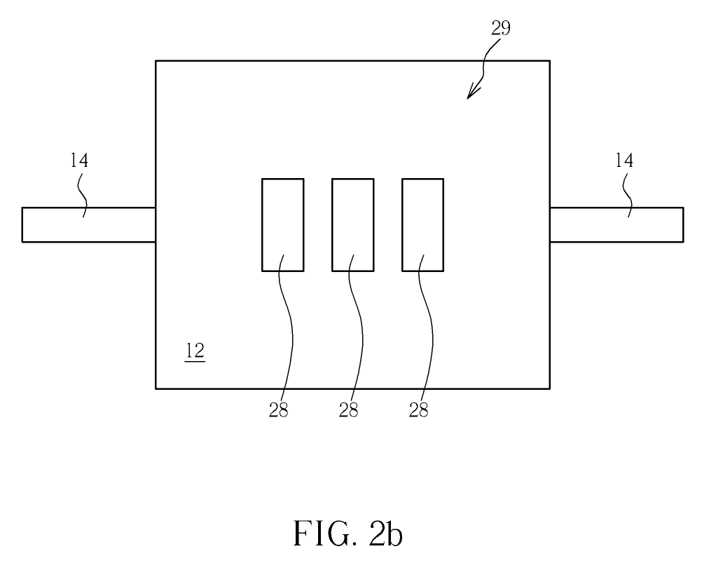

Please refer to FIG. 1 and FIG. 2, which are schematic diagrams illustrating a method of modulating resonant frequency of a torsional MEMS device according to a preferred embodiment of the present invention. As shown in FIG. 1, a torsional MEMS device 10 having a platform 12 and two hinges 14 is provided. The hinges 14 are arranged along a first direction passing through the mass center of the platform 12, and are connected between the platform 14 and a support structure 16. The platform 12 is positioned in a space 18 of the support structure 16. The platform 12 is oscillated in the space 18 using the hinge 14 as the resonant axis. An active area 20 is positioned on a front surface 24 of the platform 12. A deposition process is performed to form a metal layer on the active area 20, including Ti/Au, Cr/Au, or Al, or a visible coating that the metal layer or the visible coating layer reflects light and acts as a mirror. A device or a component may be placed in the active area 20, such as a mirror 26 shown in the present embodiment, and a micro-mechanical device or an electrical circuit can be disposed in the active area.

After the manufacture process of the torsional MEMS device 10, a driving force is provided to make the torsional MEMS device 10 oscillate. A resonant frequency test is performed to measure a raw resonant frequency of the torsional MEMS device 10. The driving force for oscillating the torsional MEMS device 10 includes electromagnetic force, electrostatic force, heating driving force, or piezoelectric force. The torsional MEMS device of the present invention may comprise a corresponding device depending on the driving force used for oscillation. For example, electromagnetic force is used for oscillating the torsional MEMS device 10 of the present invention. A magnetic material disposed on a back surface of torsional MEMS device 10 interacts with electromagnetic force generated by external metal coil, i.e., electromagnetic coil, with the electrical control. The external metal coil is located under the magnetic material. The interaction between magnet material and electromagnetic force generated by the metal coil oscillates the torsional MEMS device 10. The magnetic-material may be assembled to the torsional MEMS device after the manufacturing process of the torsional MEMS device is finished, or may use deposition or electroplating process to process the metal with magnetic property on the desired area of the back surface of the torsional MEMS device 10.

After the raw resonant frequency of the MEMS device 10 is measured, the raw resonant frequency is compared to a standard resonant frequency to confirm whether the raw resonant frequency fulfills the range of the standard resonant frequency or not. The standard resonant frequency is predetermined depending on the end products having the torsional MEMS device therein. If the raw resonant frequency is out of the range of the standard resonant frequency, for example, the raw resonant frequency is greater than the standard resonant frequency, and subsequently at least one mass increaser is provided and bonded to the torsional MEMS device 10. Please refer to FIG. 2a and FIG. 2b. FIG. 2a is a cross-sectional view diagram of the torsional MEMS device 10. FIG. 2B is a bottom view diagram of the torsional MEMS device 10. As shown in the present embodiment, a plurality of mass increasers 28 is bonded to the platform 12 of the torsional MEMS device 10. Since the active area 20 is disposed on the front surface 24 of the platform 12, the mass increasers 28 are preferably bonded to a back surface 29 of the platform 12. In the present embodiment, an adhesive material 30 is provided to bond the mass increasers 28 to the platform 12, such as a twin adhesive layer, an UV or/and thermal curing glue or a bonding material of good adhesive ability. The number of the mass increasers 28 is determined by the difference between the raw resonant frequency and the standard resonant frequency. After the mass increasers 28 are bonded to the platform 12 of the torsional MEMS device 10, the total mass of the torsional MEMS device 10 is consequently increased and so that the resonant frequency of the raw resonant frequency is reduced approaching to the standard resonant frequency of the product. The bar-shaped mass increasers 28 shown in FIG. 2 are bonded to the back surface of the platform 12. However, the number and the position of the mass increasers 28 are not limited to the present embodiment shown in FIG. 2, and are modified depending on requirements.

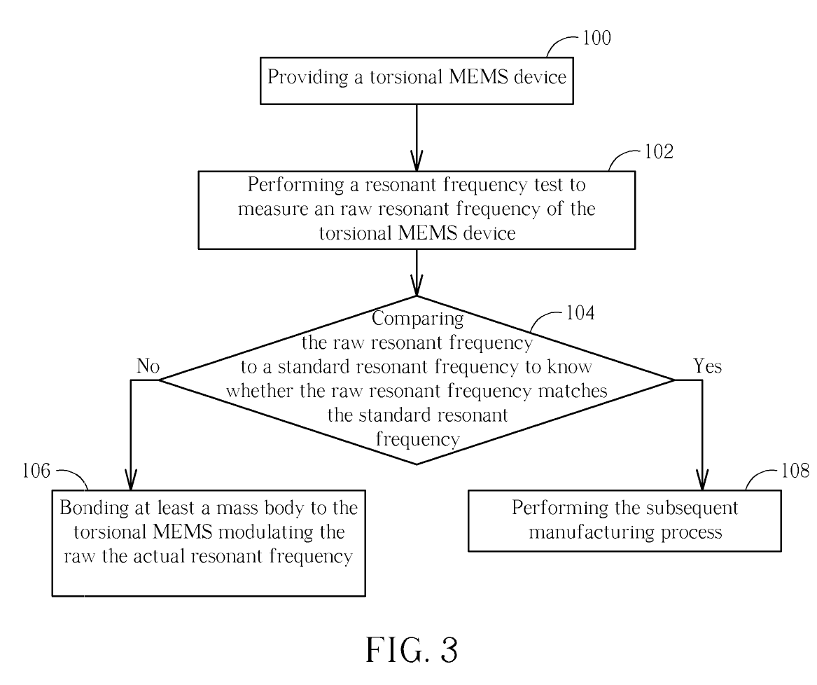

Please refer to FIG. 3, which is a flow diagram of a method for modulating the resonant frequency of the torsional MEMS device according to a preferred embodiment of the present invention. The method of modulating the resonant frequency of the torsional MEMS device is performed after the manufacturing process of the torsional MEMS device. The method of modulating the resonant frequency of the torsional MEMS device is shown as follows.

Step 100: A torsional MEMS device is provided.

Step 102: A resonant frequency test is performed to measure a raw resonant frequency of the torsional MEMS device.

Step 104: The raw resonant frequency of the torsional MEMS device is compared to a standard resonant frequency to confirm that if the raw resonant frequency matches the range of the resonant frequency.

If the raw resonant frequency of the torsional MEMS device is out of the range of the standard resonant frequency, for instance, the raw resonant frequency is greater than the standard resonant frequency, Step 106 is subsequently performed.

Step 106: At least one mass increaser 28 is bonded to the torsional MEMS device to decrease the raw resonant frequency approaching to the standard resonant frequency. It is preferable to bond the mass increaser 28 in a symmetrical manner for maintaining the mass balance of the platform 12,

On the other hand, if the raw resonant frequency matches the standard resonant frequency, Step 108 is performed subsequently.

Step 108: The torsional MEMS device is transferred for the following processes, such as packaging or combing with other elements, for manufacturing electronic products having the torsional MEMS device therein.

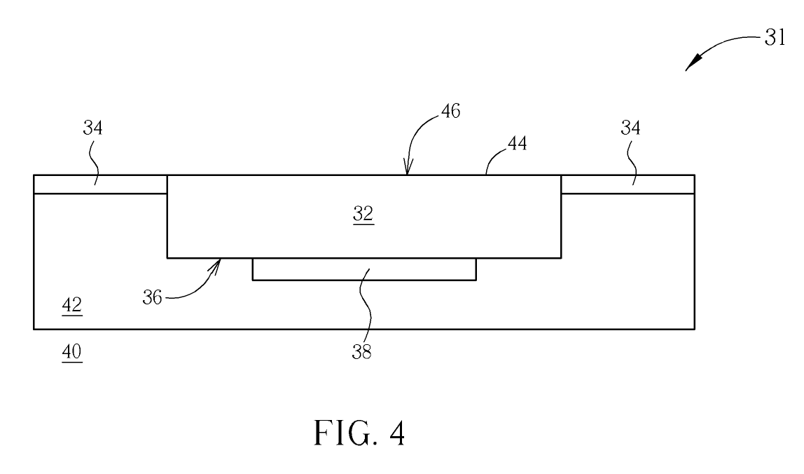

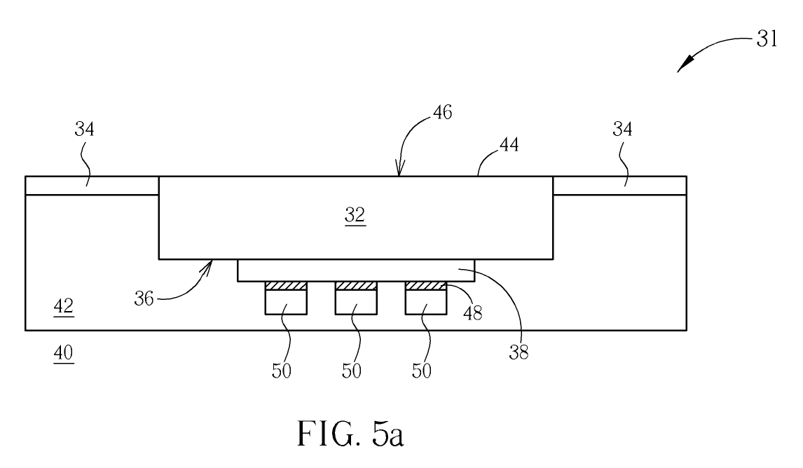

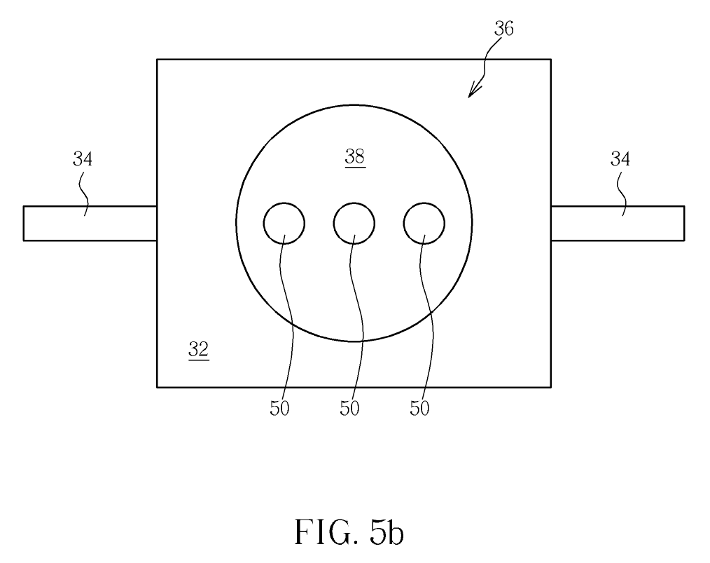

Since the type of the torsional MEMS device and the mechanism for driving the torsional MEMS device to oscillate are variable, another preferred embodiment of the present invention is provided. Please refer to FIG. 4 and FIG. 5. FIG. 4 is a schematic diagram illustrating a torsional MEMS device 31. The oscillation of the torsional MEMS device 31 is driven by an electromagnetic force. The torsional MEMS device 31 has a platform 32, two hinges 34, and a magnet 38 disposed on a back surface 36 of the platform 32. Contrary to the prior embodiment, the torsional MEMS device 31 has a magnet 36 disposed on the back surface 38 since the torsional MEMS device is driven by the electromagnetic force. Similarly, the hinges 34 are arranged along a first direction passing through the mass center of the platform 32, and are connected between the platform 32 and a support structure 40. The platform 32 is positioned in a space 38 of the support structure 40. The platform 32 is oscillated in the space 38 using the hinge 34 as the resonant axis. The torsional MEMS device 31 further includes an active area 46 disposed on a front surface 44 of the platform 32. Varieties of devices may be disposed in the active area 46 depending on the end product having the torsional MEMS device 31 therein. For instance, a mirror may be disposed in the active area 46 for being a component of a laser printer, a digital light processing device, or other electronic devices having the torsional MEMS device of the present invention for changing direction of light path.

Similar to the prior embodiment, a resonant frequency test is performed after the manufacturing process of the torsional MEMS device 31. Therefore, a raw resonant frequency is measured and is compared to a standard resonant frequency to confirm the raw resonant frequency of the torsional MEMS device matches the standard resonant frequency. If the raw resonant frequency of the torsional MEMS device is out of the range of the standard resonant frequency, for instance, the raw resonant frequency is greater than the standard resonant frequency. Subsequently, at least one mass increaser is bonded to the torsional MEMS device 31. Please refer to FIG. 5a and FIG. 5b. FIG. 5a is a cross-sectional view diagram of the torsional MEMS device 31. FIG. 5b is a bottom view diagram of the torsional MEMS device 31. As show in FIG. 5a, an adhesive material 48 is provided for bonding a plurality of mass increasers 50 to the back surface 36 of the platform 32, for instance, the mass increasers 50 are bonded to the surface of the magnet 38. Therefore, the total mass of the torsional MEMS device 31 is increased and the raw resonant frequency is reduced approaching to the standard resonant frequency. Furthermore, the mass increasers 50 are bonded along the first direction as the hinges 34 arranged without leading extra torque during oscillation of the torsional MEMS device 31. The shape of the mass increasers 50 is not limited to the round-shaped mass increasers 50 shown in FIG. 5b, the shape of the mass increasers may be modified according to the figure of the torsional MEMS device 31. Since the torsional MEMS device 31 is driven by the electromagnetic force, the material of the mass increasers 50 is preferably selected from nonmagnetic material to prevent interference from the mass increasers 50.

The torsional MEMS device of the present invention may be manufactured by a series of semiconductor processes, such as a lithography process, an etch process, a grinding process, and a CMP process. The pattern of the platform and the hinges may be defined on the silicon wafers by the same mask. When the torsional MEMS device is formed on a wafer, it can be measured the resonant frequency. If the torsional MEMS device is formed on a normal wafer, which has a plurality of the same torsional MEMS device thereon, and has free space for its free torsion, which means that the torsional MEMS device is suspending without constraint on the wafer, the resonant frequency measurement and resonant frequency modulation of the torsional MEMS devices formed on a normal wafer are performed in a wafer-level scale. The raw resonant frequency of the respective torsional MEMS device may be modulated individually but the wafer still keeps as the wafer-level scale. When the torsional MEMS device is formed on a thin wafer and there is no free space for the torsional MEMS device to resonate, which means that the torsional MEMS device is fixed on the wafer even after etch through process, the resonant frequency of the hinge of the torsional MEMS device may be measured and modulated after these devices are divided individually. In other words, each torsional MEMS device is measured and modulated in a chip-level scale. Moreover, if the modulated raw resonant frequency is less than the standard resonant frequency after the mass increasers are bonded, a portion of the mass increasers may be removed for reducing total mass of the torsional MEMS device and increasing the raw resonant frequency approaching to the range of the standard resonant frequency.

In conclusion, the present invention provides a torsional MEMS device capable of modulating the resonant frequency thereof. A raw resonant frequency test is performed after the manufacturing process of the torsional MEMS device. The raw resonant frequency is compared to the standard resonant frequency. If the raw resonant frequency is greater than the standard resonant frequency, at least one mass increaser is bonded to the torsional MEMS device. The number of the mass increaser and the predetermined bonding site for the mass increaser is determined depending on the balance of the platform. An adhesive material is used, such as a twin adhesive, an UV tape or a thermal curing tape, to bond the mass increaser to the torsional MEMS device. Accordingly, the total mass of the torsional MEMS device is increased and the resonant frequency is reduced. The abnormal torsional MEMS device is prevented from scrapping after the mass increaser is bonded, and therefore, the yield of the product is increased. Furthermore, the position for bonding the mass increaser is not limited to the preferred embodiments of the present invention. The mass increaser may be disposed in a place on the platform without hindering the performance of the devices disposed in the active area. The number, the shape, and the size of the mass increaser may be modified. The device disposed in the active area is not limited to the mirror shown in the present embodiments. Mechanical structures, sensors, or electrical circuits may be disposed in the active area depending on the final product having the torsional MEMS device therein.

Those skilled in the art will readily observe that numerous modifications and alterations of the device and method may be made while retaining the teachings of the invention.

What is claimed is:

1. A method of adjusting the resonant frequency of a torsional MEMS device, comprising:
providing a torsional MEMS device, the torsional MEMS device comprising a support structure, a platform, and at least two hinges connecting the support structure and the platform;
performing a resonant frequency test to measure a raw resonant frequency of the torsional MEMS device; and
comparing the raw resonant frequency to a standard resonant frequency, and bonding at least one mass increaser to the torsional MEMS device to increase the mass of the torsional MEMS device for adjusting the raw resonant frequency approaching to the standard resonant frequency when the raw resonant frequency is greater than the standard resonant frequency.

2. The method of claim 1, wherein the platform is oscillating along the hinges, which is the resonant axis of the platform.

3. The method of claim 1, wherein the platform comprises a front surface and a back surface.

4. The method of claim 3, wherein the mass increaser is bonded to the front surface of the platform.

5. The method of claim 3, wherein the mass increaser is bonded to the back surface of the platform.

6. The method of claim 5, wherein the platform comprises an active area and a non-active area disposed on the front surface.

7. The method of claim 6, wherein the platform comprises a mirror disposed in the active area of the platform.

8. The method of claim 6, wherein the non-active area is positioned around the active area.

9. The method of claim 1, wherein the mass increaser comprises silicon.

10. The method of claim 1, wherein the mass increaser is arranged along the hinge.

11. The method of claim 1, wherein the torsional MEMS device comprises a magnet.

12. The method of claim 11, wherein the mass increaser is bonded to a surface of the magnet respective to the surface of the magnet bonded to the platform.

13. The method of claim 1, wherein the mass increaser comprises nonmagnetic material.

14. The method of claim 13, wherein the mass increaser is bonded to the platform by an adhesive material.

15. The method of claim 1, wherein the torsional MEMS device is formed on a normal wafer, which comprises a plurality of torsional MEMS device, and the measurement and the modulation of the raw resonant frequency of the raw resonant frequency of the torsional MEMS devices are performed in a wafer-level scale.

16. The method of claim 1, wherein the torsional MEMS device is formed on a thin wafer, which comprises a plurality of torsional MEMS device, and the measurement and the modulation of the raw resonant frequency of the raw resonant frequency of the torsional MEMS device are performed in a chip-level scale.

17. The method of claim 1, wherein the mass increaser is bonded and disposed symmetrically for maintaining the mass balance of the platform.
